(19) United States
(12) Patent Application Publication
(10) Pub. No.: US 2024/0171030 A1
(43) Pub. Date: May 23, 2024

(54) MOTOR

(71) Applicant: LG INNOTEK CO., LTD., Seoul (KR)

(72) Inventor: Yeong Min KOO, Seoul (KR)

(21) Appl. No.: 18/550,051

(22) PCT Filed: Mar. 11, 2022
(86) PCT No.: PCT/KR2022/003453

§ 371 Date: Sep. 11, 2023

(30) Foreign Application Priority Data
Mar. 11, 2021 (KR) 10-2021-0032000

(51) Int. Cl. H02K 3/52

(52) U.S. Cl. CPC H02K 3/522; H02K 2203/12

(57) ABSTRACT

An embodiment provides a motor comprising: a shaft; a rotor coupled to the shaft; and a stator disposed so as to correspond to the rotor. The stator comprises: a stator core; an insulator coupled to the stator core; and coils disposed on the insulator, wherein the coils comprise a first coil and a second coil wound around the insulator, and the diameter of the first coil and the diameter of the second coil are different from each other.

### TECHNICAL FIELD

The present invention relates to a motor.

### BACKGROUND ART

A motor includes a rotor and a stator. In addition, the rotor rotates due to an electrical interaction between the rotor and the stator. The stator includes a coil which receives power.

The coil is wound around inside the stator a plurality of times. In this case, the coil may be subject to spatial constraints during a winding process. In addition, the wound coil may be mechanically or electrically interfered with by an adjacent coil.

### DISCLOSURE

### Technical Problem

Accordingly, the present invention is directed to providing a motor in which a winding volume of a coil is reduced and electrical characteristics of the coil are controlled.

### Technical Solution

One aspect of the present invention provides a motor including a shaft, a rotor coupled to the shaft, and a stator disposed to correspond to the rotor, wherein the stator includes a stator core, an insulator coupled to the stator core, and a coil disposed on the insulator, a coil includes a first coil and a second coil wound around the insulator, and a diameter of the first coil differs from a diameter of the second coil.

Another aspect of the present invention provides a motor including a shaft, a rotor coupled to the shaft, and a stator disposed to correspond to the rotor, wherein the stator includes a stator core, an insulator coupled to the stator core, and a coil disposed on the insulator, the coil includes a first coil and a second coil, the first coil is wound around the insulator N times, and the second coil is wound around the first coil M times.

The first coil may be disposed on the insulator, and the second coil may be disposed on the first coil.

The first coil may be wound around the insulator N times, and the second coil may be wound around the insulator M times.

The number (N) of windings of the first coil may be greater the number (M) of windings of the second coil.

A ratio of the diameter of the second coil to the diameter of the first coil may be in a range of 0.3 to 0.8.

The motor may include a busbar electrically connected to the coil, and the end portion of the first coil and the end portion of the second coil may be connected to the busbar by fusing.

The end portion of the first coil and the end portion of the second coil may be electrically connected by fusing.

The first coil and the second coil may be wound in the same direction.

The first coil may include a first body and two first end portions, the second coil may include a second body and two second end portions, and a circumferential distance between the two first end portions may be smaller than a circumferential distance between the two second end portions.

The number (N) of windings of the first coil may be the same as the number (M) of windings of the second coil, and the diameter of the first coil may be greater than the diameter of the second coil.

The diameter of the first coil and the diameter of the second coil may be the same.

The number (N) of windings of the first coil may be greater than the number (M) of windings of the second coil.

### Advantageous Effects

According to an embodiment, since a first coil and a second coil of which diameters are smaller than a diameter of a coil of a conventional stator are wound through a double method, a winding volume of the coil of a stator can be reduced, and a cross-sectional area of the coil can be increased.

Accordingly, the utilization of a space inside the stator can be improved, and a resistance specification of the coil can be satisfied.

According to an embodiment, electrical characteristics of a coil according to customer requirements can be satisfied by adjusting diameters or numbers of windings of a first coil and a second coil.

### DESCRIPTION OF DRAWINGS

FIG. 1 is a cross-sectional view illustrating a motor according to an embodiment.

FIG. 2 is a perspective view illustrating a stator core, an insulator, and a coil.

FIG. 3 is a perspective view illustrating a shape of a first coil wound around the insulator.

FIG. 4 is a perspective view illustrating a shape of a second coil wound around the first coil.

FIG. 5 is a cross-sectional view illustrating the shape along line A-A′ in FIG. 4.

FIGS. 6A to 6C are views illustrating modified examples of the coil.

### MODES OF THE INVENTION

Hereafter, an exemplary embodiment of the present invention will be described in detail with reference to the accompanying drawings.

A direction parallel to a longitudinal direction (vertical direction) of a shaft is referred to as an axial direction, a direction perpendicular to the axial direction based on the shaft is referred to as a radial direction, and a direction along a circle having a radius in the radial direction based on the shaft is referred to as a circumferential direction.

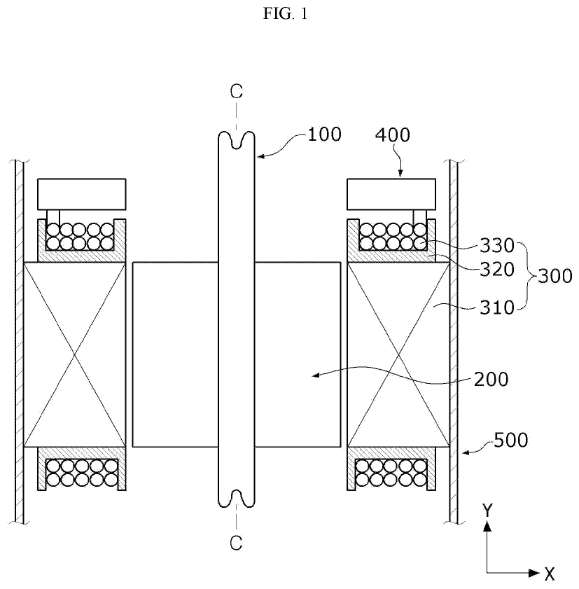

FIG. 1 is a cross-sectional view illustrating a motor according to an embodiment. In FIG. 1, an X direction may be a radial direction, and a Y direction may an axial direction. In addition, a reference symbol “C” illustrated in FIG. 1 may be a rotary center of the shaft 100.

Referring to FIG. 1, the motor may include the shaft 100, a rotor 200, a stator 300, a busbar 400, and a housing 500.

Hereafter, the term “inward” is a direction from the housing 500 toward the shaft 100 which is a center C of the motor, and the term “outward” is a direction opposite to “inward,” that is, the direction from the shaft 100 toward the housing 500.

The shaft 100 may be coupled to the rotor 200. When a current is supplied, an electromagnetic interaction occurs between the rotor 200 and the stator 300, the rotor 200 rotates, and the shaft 100 rotates in conjunction with the rotor 200. The shaft 100 may be connected to a steering system of a vehicle and transmit power to the steering system.

The rotor 200 rotates due to an electrical interaction between the rotor 200 and the stator 300. The rotor 200 may be disposed inside the stator 300. The rotor 200 may include a rotor core and a rotor magnet disposed on the rotor core.

The stator 300 is disposed outside the rotor 200. The stator 300 may include a stator core 310, a coil 320, and an insulator 330 mounted on the stator core 310. The coil 320 may be wound around the insulator 330. The insulator 330 is disposed between the coil 320 and the stator core 310. The coil induces an electrical interaction with the rotor magnet.

The busbar 400 is disposed on the stator 300. The busbar 400 may include terminals connected to the coil 330 of the stator 300.

The housing 500 may be disposed outside the stator 300. The housing 500 may be a cylindrical member of which one side is open. A shape or material of the housing 500 may be variously changed. For example, the housing 500 may be formed of a metal material resistant to high temperatures.

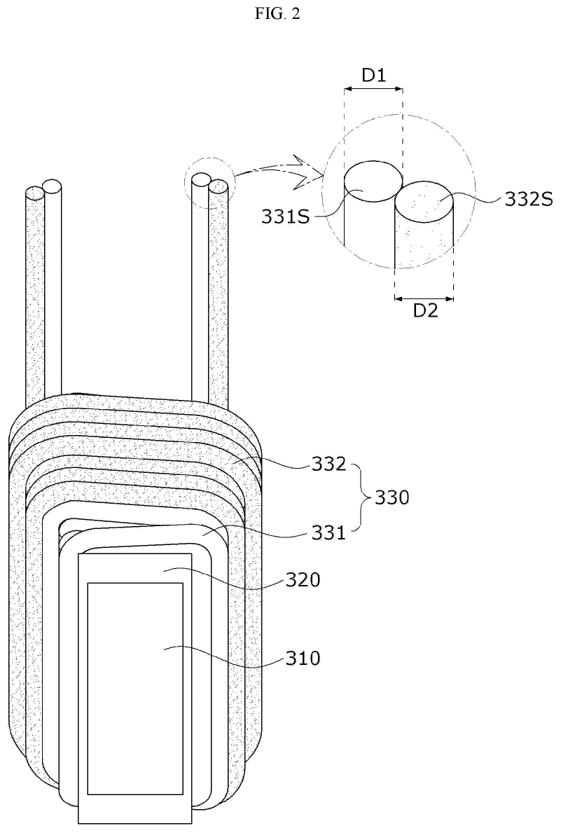

FIG. 2 is a perspective view illustrating the stator core, the insulator, and the coil.

Referring to FIG. 2, the coil 330 may include a first coil 331 and a second coil 332. The first coil 331 and the second coil 332 may be separated from each other. The first coil 331 may be disposed on the insulator 320. The second coil 332 may be disposed on the first coil 331, but is not limited thereto. For example, the second coil 332 may be wound around the first coil 331 being wound around. Accordingly, as illustrated in FIG. 2, first end portions 331S of the first coil 331 may be disposed at an inner side than second end portions 332S of the second coil 332 in a circumferential direction. That is, a circumferential distance between two first end portions 331S is smaller than a circumferential distance between two second end portions 332S.

The first coil 331 and the second coil 332 may have different cross-sectional areas.

A diameter D1 of the first coil 331 and a diameter D2 of the second coil 332 may be in the range of 0.5 to 5 mm. In this case, the diameter D1 of the first coil 331 may differ from the diameter D2 of the second coil 332. For example, the diameter D1 of the first coil 331 may be greater than the diameter D2 of the second coil 332.

According to the embodiment, a ratio of the diameter D2 of the second coil 332 to the diameter D1 of the first coil 331 may be in the range of 0.3 to 0.8.

The end portions of the first coil 331 and the second coil 332 may be electrically connected. The end portions of the first coil 331 and the second coil 332 may be electrically connected by fusing. Accordingly, the two coils can be used as one coil.

The first coil 331 may include the first end portions 331S. In addition, the second coil 332 may include the second end portions 332S. The first end portions 331S and the second end portions 332S may be disposed to be spaced apart from the insulator 320 in consideration of a fusing process.

The first end portions 331S and the second end portions 332S may be connected to the busbar 400. The first end portions 331S and the second end portions 332S may be connected to the terminals of the busbar 400 by fusing.

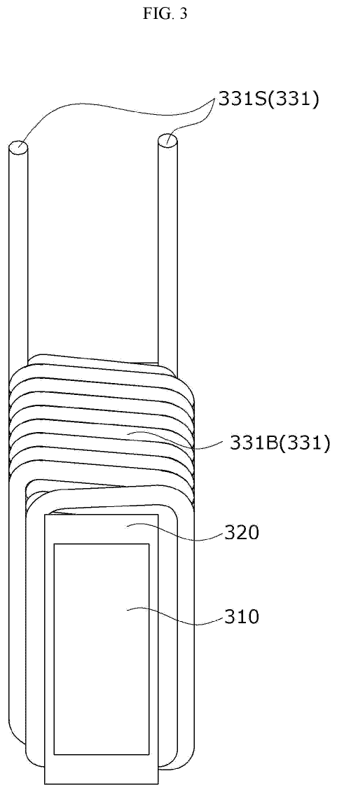

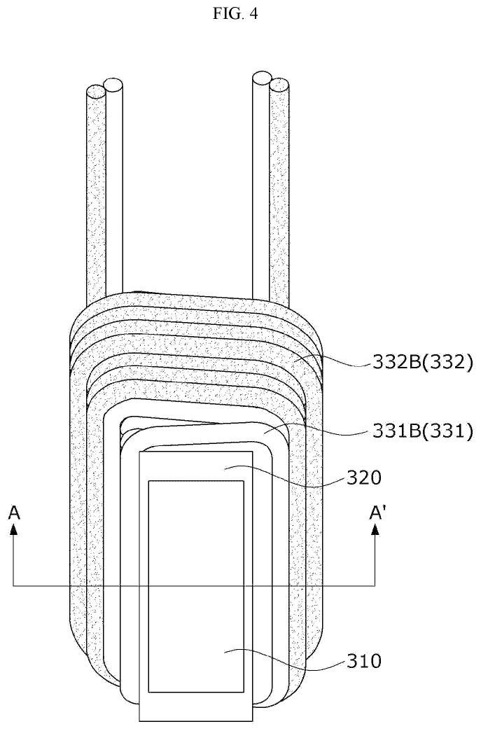

FIG. 3 is a perspective view illustrating a shape of the first coil wound around the insulator, and FIG. 4 is a perspective view illustrating a shape of the second coil wound around the first coil.

Referring to FIGS. 3 and 4, the first coil 331 and the second coil 332 may be sequentially wound.

The first coil 331 may be wound around the insulator 320. The first coil 331 may be wound in one direction. In addition, the second coil 332 may be wound in the same direction as a direction in which the first coil 331 is wound. For example, when the first coil 331 is wound clockwise, the second coil 332 may also be wound clockwise.

The first coil 331 may include a first body 331B and two first end portions 331S.

The first body 331B may be disposed on the insulator 320. The first body 331B may be disposed as a plurality of layers on the insulator 320. According to the embodiment, the first body 331B may be wound around the insulator 320 N times. Accordingly, the first body 331B may be disposed on the insulator 320 to have a predetermined thickness.

The first end portions 331S may be disposed at both sides of the first body 331B. The first end portions 331S at both sides may be spaced apart from each other in the circumferential direction with the second body 332B interposed therebetween. The first end portions 331S may be spaced apart from the insulator 320 in an axial direction. The first end portions 331S may be connected to the busbar 400.

The second coil 332 may include a second body 332B and two second end portions 332S.

The second body 332B may be disposed on the first body 331B. The first body 331B and the second body 332B may overlap. The first body 331B and the second body 332B may be separated from each other. According to the embodiment, the second body 332B may be wound around the first body 331B M times. Accordingly, the second body 332B may be disposed on the first body 331B to have a predetermined thickness. In this case, M and N may be natural numbers greater than 1. In addition, N may be greater than or equal to M.

The second end portions 332S may be disposed at two sides of the second body 332B. The second end portions 332S may be spaced apart from each other in the circumferential direction with the second body 332B interposed therebetween. In addition, the second end portions 332S may be spaced apart from the first coil 331 in the axial direction. The second end portions 332S may overlap the first end portions 331S. The second end portions 331S may be connected to the terminals of the busbar 400 by fusing.

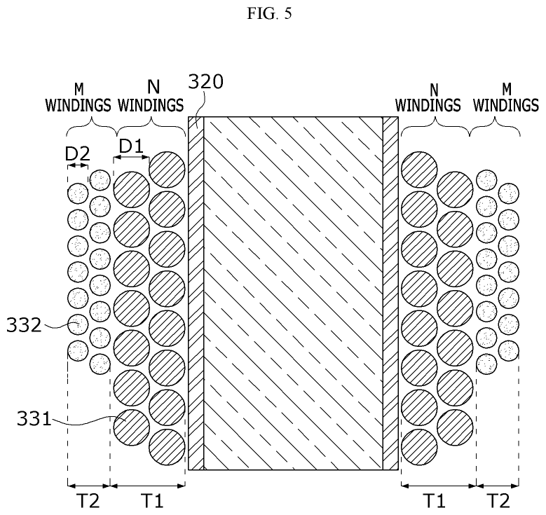

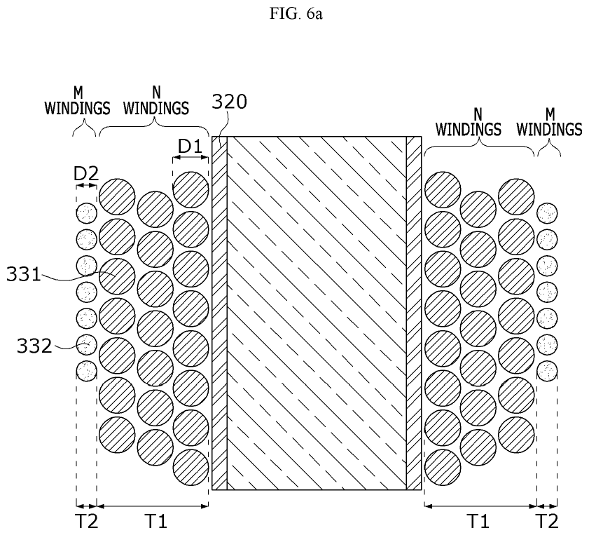

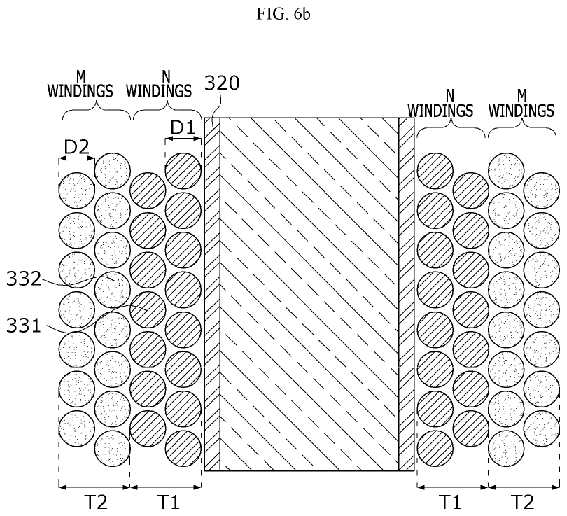

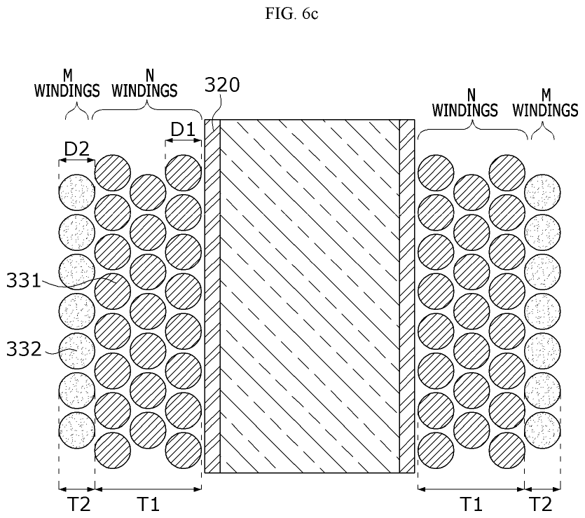

FIG. 5 is a cross-sectional view illustrating the shape along line A-A′ in FIG. 4, and FIGS. 6A to 6C are views illustrating modified examples of the coil.

Referring to FIG. 5, the diameter D1 of the first coil 331 may be greater than the diameter D2 of the second coil 332. The ratio of the diameter D2 of the second coil 332 to the diameter D1 of the first coil 331 may be in the range of 0.3 to 0.8. According to the embodiment, the ratio of the diameter D2 of the second coil 332 to the diameter D1 of the first coil 331 may be 0.5. A volume ratio of the above-described wound coil can increase.

The first coil 331 may be disposed on the insulator 320. In addition, the second coil 332 may be disposed on the first coil 331. The first coil 331 may be disposed as N layers on the insulator 320. In addition, the second coil 332 may be disposed as M layers on the first coil 331. In this case, the number N of windings of the first coil 331 and the number M of windings of the second coil 332 may be the same.

A circumferential thickness T1 of the first coil 331 may be greater than a circumferential thickness T2 of the second coil 332. In this case, a thickness of the coil 330 wound around the insulator 320 may be the same as the sum of the circumferential thickness T1 of the first coil 331 and the circumferential thickness T2 of the second coil 332. According to the embodiment, the thickness of the coil 330 wound around the insulator 320 may be smaller than a thickness of a coil wound around an insulator of a conventional motor. Accordingly, a volume of the coil 330 can be reduced. That is, in the motor according to the embodiment, since two coils with different diameters are wound around through a double winding method, the volume occupied by the coil 330 in the stator 300 can be reduced. In this case, in the coil of the conventional motor, a winding method using one coil may be used instead of the double winding method using two coils.

Referring to FIG. 6A, the number N of windings of a first coil 331 may differ from the number M of windings of a second coil 332. In this case, a diameter D1 of the first coil 331 may be greater than a diameter D2 of the second coil 332 like FIG. 5.

The first coil 331 may be disposed as N layers on an insulator 320. In addition, the second coil 332 may be disposed as M layers on the first coil 331. In this case, the number N of windings of the first coil 331 may be greater than the number M of windings of the second coil 332. According to the embodiment, the second coil 332 may be wound around the first coil 331 one time. In this case, the first coil 331 may be wound around three times.

A circumferential thickness T1 of the first coil 331 on the insulator 320 may be greater than a circumferential thickness T2 of the second coil 332. In this case, the circumferential thickness T1 of the first coil 331 may be greater than the circumferential thickness T1 of the first coil 331 illustrated in FIG. 5.

Referring to FIG. 6B, a diameter D1 of a first coil 331 may be smaller than or equal to a diameter D2 of a second coil 332. In this case, the first coil 331 and the second coil 332 may overlap in a circumferential direction. In addition, the number N of windings of the first coil 331 and the number M of windings of the second coil 332 may be the same. In this case, a circumferential thickness T1 of the first coil 331 and the circumferential thickness T2 of the second coil 332 may be the same.

Referring to FIG. 6C, the number N of windings of a first coil 331 may differ from the number M of windings of a second coil 332. A diameter D1 of the first coil 331 may be the same as a diameter D2 of the second coil 332 like FIG. 6B. In this case, a circumferential thickness T1 of the first coil 331 may be greater than a circumferential thickness T2 of the second coil 332. In this case, the circumferential thickness T1 of the first coil 331 may be greater than the circumferential thickness T1 of the first coil 331 illustrated in FIG. 6B.

In the motor according to the present invention, since the first and second coils of which the diameters are smaller than the diameter of the coil disposed in the conventional motor are wound around through a double method, the winding volume occupied by the coil 330 in the stator 300 can be reduced, and an overall cross-sectional area can be increased

Accordingly, the utilization of a space inside the stator can be improved, and a resistance specification of the coil can be satisfied.

In addition, in the motor according to the present invention, electrical characteristics according to customer requirements of a coil can be satisfied by adjusting the diameter or the number of windings of each of the first coil 331 and the second coil 332. That is, in the motor according to the embodiment, an output of the motor can be more finely adjusted by adjusting the diameter or the number of windings of each of the first coil 331 and the second coil 332.

In the above embodiments, an example of an inner rotor type motor has been described, but the present invention is not limited thereto. The present invention can also be applied to an outer rotor type motor. In addition, the present invention can be used in various devices such as vehicles or home appliances.

### REFERENCE NUMERALS

100: SHAFT
200: ROTOR
300: STATOR
310: STATOR CORE
320: INSULATOR
330: COIL
331: FIRST COIL
332: SECOND COIL
400: BUSBAR
500: HOUSING

1. A motor comprising:
a shaft;
a rotor coupled to the shaft; and
a stator disposed to correspond to the rotor,
wherein the stator includes a stator core, an insulator coupled to the stator core, and a coil disposed on the insulator,
the coil includes a first coil and a second coil wound around the insulator,
a diameter of the first coil differs from a diameter of the second coil, and
an inner side of the second coil overlaps with the first coil in a circumferential direction.

2. The motor of claim 1, wherein:
the first coil is disposed on the insulator; and
the second coil is disposed on the first coil.

3. The motor of claim 1, wherein:
the first coil is wound around the insulator N times; and
the second coil is wound around the insulator M times.

4. The motor of claim 3, wherein the number (N) of windings of the first coil is greater than the number (M) of windings of the second coil.

5. The motor of claim 4, wherein a ratio of the diameter of the second coil to the diameter of the first coil is in a range of 0.3 to 0.8.

6. A motor comprising:
a shaft;
a rotor coupled to the shaft; and
a stator disposed to correspond to the rotor,
wherein the stator includes a stator core, an insulator coupled to the stator core, and a coil disposed on the insulator,
the coil includes a first coil and a second coil,
the first coil is wound around the insulator N times,
the second coil is wound around the first coil M times,
a diameter of the first coil differs from a diameter of the second coil, and
an inner side of the second coil overlaps with the first coil in a circumferential direction.

7. The motor of claim 6, wherein the number (N) of windings of the first coil is greater than the number (M) of windings of the second coil.

8. The motor of claim 6, wherein:
the first coil is disposed on the insulator; and
the second coil is disposed on the first coil.

9. The motor of claim 6, wherein a ratio of a diameter of the second coil to a diameter of the first coil is in a range of 0.3 to 0.8.

10. The motor of claim 1, comprising a busbar electrically connected to the coil,
wherein an end portion of the first coil and an end portion of the second coil are connected to the busbar by fusing.

11. The motor of claim 1, wherein an end portion of the first coil and an end portion of the second coil are electrically connected by fusing.

12. The motor of claim 1, wherein the first coil and the second coil are wound in the same direction.

13. The motor of claim 12, wherein:
the first coil includes a first body and two first end portions;
the second coil includes a second body and two second end portions; and
a circumferential distance between the two first end portions is smaller than a circumferential distance between the two second end portions.

14. The motor of claim 3, wherein:
the number (N) of windings of the first coil is the same as the number (M) of windings of the second coil; and
the diameter of the first coil is greater than the diameter of the second coil.

15. A motor comprising:
a shaft;
a rotor coupled to the shaft; and
a stator disposed to correspond to the rotor,
wherein the stator includes a stator core, an insulator coupled to the stator core, and a coil disposed on the insulator,
the coil includes a first coil and a second coil,
the diameter of the first coil and the diameter of the second coil are the same, and
the number (N) of windings of the first coil is greater than the number (M) of windings of the second coil.

16. The motor of claim 6, comprising a busbar electrically connected to the coil,
wherein an end portion of the first coil and an end portion of the second coil are connected to the busbar by fusing.

17. The motor of claim 6, wherein an end portion of the first coil and an end portion of the second coil are electrically connected by fusing.

18. The motor of claim 6, wherein the first coil and the second coil are wound in the same direction.

19. The motor of claim 6, wherein:
the number (N) of windings of the first coil is the same as the number (M) of windings of the second coil; and
the diameter of the first coil is greater than the diameter of the second coil.

20. The motor of claim 18, wherein:
the first coil includes a first body and two first end portions;
the second coil includes a second body and two second end portions; and
a circumferential distance between the two first end portions is smaller than a circumferential distance between the two second end portions.
